(19) United States
(12) Patent Application Publication
(10) Pub. No.: US 2024/0134383 A1
(43) Pub. Date: Apr. 25, 2024

(54) MOBILE BODY AUTHENTICATION APPARATUS, MOBILE BODY AUTHENTICATION SYSTEM, MOBILE BODY AUTHENTICATION METHOD, AND NON-TRANSITORY COMPUTER READABLE MEDIUM

(71) Applicant: NEC Corporation, Minato-ku, Tokyo (JP)

(72) Inventors: Takuya Nomura, Tokyo (JP); Takuya Hisamoto, Tokyo (JP); Kenichi Kijima, Tokyo (JP)

(73) Assignee: NEW Corporation, Minato-ku, Tokyo (JP)

(21) Appl. No.: 18/278,513

(22) PCT Filed: Dec. 15, 2021
(86) PCT No.: PCT/JP2021/046217

§ 371 Date: Aug. 22, 2023

(30) Foreign Application Priority Data
Mar. 30, 2021 (JP) 2021-062053

(51) Int. Cl. G05D 1/221; H04W 12/06

(52) U.S. Cl. CPC G05D 1/221; H04W 12/06

(57) ABSTRACT

A mobile body authentication apparatus capable of preventing an autonomously movable mobile body from illegally moving without permission is provided. A mobile body authentication apparatus includes at least one memory configured to store instructions, and at least one processor configured to execute the instructions to: acquire, from an autonomously movable mobile body, remote identification information, which is information for managing a remote operation of the mobile body, position information indicating the current position of the mobile body, time information that indicates the current time in the mobile body, and authentication information; and execute collation based on the whole of part of the information; and output the result of collation.

### TECHNICAL FIELD

The present disclosure relates to a mobile body authentication apparatus, a mobile body authentication system, a mobile body authentication method, and a program.

### BACKGROUND ART

In recent years, mobile bodies such as unmanned aircrafts, autonomous robots, or self-driving vehicles that move autonomously or by remote control have become more and more widespread. Further, for a wider spread of the mobile bodies, it is expected that a technique for safely operating these mobile bodies will be developed.

Patent Literature 1 discloses a method for determining a level of authentication regarding an operation of an unmanned aircraft (UAV). This method includes a step of receiving information regarding an unmanned aircraft, and a step of determining, based on the received information and the type of a user who operates the unmanned aircraft or the level of the skill that this user has, the level of authentication of a user identifier of the unmanned aircraft. This method further includes a step of issuing, based on a result of the above determination, an authentication of the unmanned aircraft or the user identifier, and a step of allowing an operation of the unmanned aircraft by the user based on the issuance of the authentication.

Patent Literature 2 discloses a method for identifying a flying object using a management server and an authentication terminal. This identification method includes a step of transmitting individual information of a flying object to a management server by a user terminal that has received the individual information of the flying object. Further, this identification method includes a step of evaluating, by the management server, individual information, a step of generating identification information based on the above evaluation, and a step of storing identification information in an identification information database and transmitting the identification information to a user terminal. Further, this identification method includes a step of transmitting, by the authentication terminal that has received the identification information of the flying object, identification information to the management server, and a step of referring to, by the management server, an identification information database and authenticating the received identification information.

Patent Literature 3 discloses a method for authenticating communication between a first unmanned aircraft and a second unmanned aircraft. This method stores, under the control of an on-board computer system of the first unmanned aircraft, information specifying a set of operations to be performed by the first unmanned aircraft, receives a message and authentication information for this message from a second wireless device, determines that this message is authentic, and corrects the aforementioned information. The above authentication information is specific to the sender of the above message. The above determination is made based on at least a part of the authentication information and the above correction is made based on at least a part of the message.

### CITATION LIST

### Patent Literature

[Patent Literature 1] Japanese Unexamined Patent Application Publication No. 2020-144870
[Patent Literature 2] Japanese Unexamined Patent Application Publication No. 2019-101828
[Patent Literature 3] Published Japanese Translation of PCT International Publication for Patent Application, No. 2018-511248

### SUMMARY OF INVENTION

### Technical Problem

As described above, it is desired to promote the widespread use of mobile bodies while taking safety into consideration. In order to achieve this, it is required to prevent mobile bodies from illegally moving without permission by spoofing or the like. Therefore, a technique for preventing unauthorized usage of mobile bodies has been required. None of Patent Literature 1-3 is able to sufficiently prevent unauthorized usage of mobile bodies.

The present disclosure has been made in view of the aforementioned problem, and an object of the present disclosure is to provide a mobile body authentication apparatus, a mobile body authentication system, a mobile body authentication method, and a program capable of preventing an autonomously movable mobile body from illegally moving without permission.

### Solution to Problem

A mobile body authentication apparatus according to a first example aspect of the present disclosure includes an acquisition unit, a collation unit, and an output unit. The acquisition unit acquires, from an autonomously movable mobile body, remote identification information, which is information for managing a remote operation of the mobile body, position information indicating a current position of the mobile body, time information indicating a current time in the mobile body, and authentication information. The collation unit executes collation based on all or part of the information acquired by the acquisition unit. The output unit outputs a result of the collation in the collation unit.

In a mobile body authentication method according to a second example aspect of the present disclosure, a computer executes the following processing. The processing acquires, from an autonomously movable mobile body, remote identification information, which is information for managing a remote operation of the mobile body, position information indicating a current position of the mobile body, time information indicating a current time in the mobile body, and authentication information. The processing executes collation based on all or part of the acquired information and outputs a result of the collation.

A program according to a third example aspect of the present disclosure is a program for causing a computer to execute the following processing. The processing acquires, from an autonomously movable mobile body, remote identification information, which is information for managing a remote operation of the mobile body, position information indicating a current position of the mobile body, time information indicating a current time in the mobile body, and authentication information. The processing executes collation based on all or part of the acquired information and outputs a result of the collation.

### Advantageous Effects of Invention

According to the present disclosure, it is possible to provide a mobile body authentication apparatus, a mobile body authentication system, a mobile body authentication method, and a program capable of preventing an autonomously movable mobile body from illegally moving without permission.

### BRIEF DESCRIPTION OF DRAWINGS

FIG. 1 is a block diagram showing one configuration example of a mobile body authentication apparatus according to a first example embodiment;

FIG. 2 is a flowchart for describing one example of a mobile body authentication method according to the first example embodiment;

FIG. 3 is a schematic diagram showing one configuration example of a mobile body authentication system according to a second example embodiment;

FIG. 4 is a block diagram showing one configuration example of a mobile body shown in FIG. 3;

FIG. 5 is a diagram showing one example of remote identification information;

FIG. 6 is a schematic view for describing transmission and reception of information and collation in the mobile body authentication system shown in FIG. 3,

FIG. 7 is a flowchart for describing one example of collation processing in the mobile body authentication system shown in FIG. 3; and

FIG. 8 is a block diagram illustrating a hardware configuration of a computer.

### EXAMPLE EMBODIMENT

Hereinafter, the present disclosure will be described based on embodiments of the present disclosure. However, the disclosure set forth in claims is not limited to the following embodiments. Moreover, it is not absolutely necessary to provide all the configurations to be described in the following embodiments as means for solving the problems. For the sake of clarification of the description, the following description and the drawings are partially omitted and simplified as appropriate. Throughout the drawings, the same symbols are attached to the same or equivalent elements and overlapping descriptions are omitted as necessary. Further, in the drawings, unidirectional arrows may be attached. Each unidirectional arrow indicates the direction of the flow of one signal (data) in a simplified manner, and does not exclude a case in which signals are transmitted bidirectionally.

### First Example Embodiment

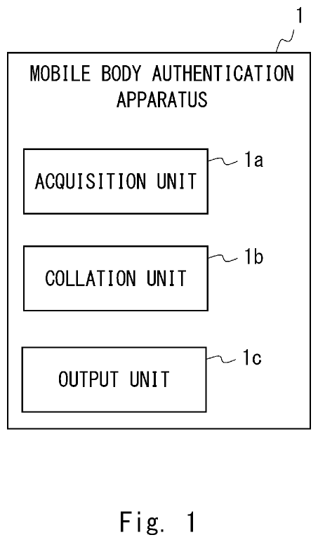

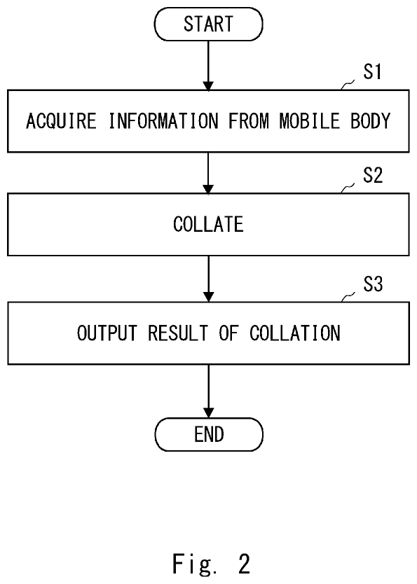

With reference to FIGS. 1 and 2, a first example embodiment will be described.

FIG. 1 is a block diagram showing one configuration example of a mobile body authentication apparatus according to the first example embodiment. As shown in FIG. 1, a mobile body authentication apparatus 1 according to this example embodiment is an apparatus for performing authentication of an autonomously movable mobile body, and includes an acquisition unit 1a, a collation unit 1b, and an output unit 1c.

The mobile body to be authenticated may be any autonomously movable mobile body and may be, for example, a vehicle, a flying object, a ship, an autonomous moving robot (a walking robot) of various sizes or shapes. The aforementioned mobile body may or may not be required to have a manipulator on board, or may or may not be able to have a manipulator on board. It is sufficient that the mobile body be able to autonomously move. The aforementioned vehicle may include a self-driving car.

The aforementioned flying object may be an unmanned aircraft (Unmanned Aerial Vehicle (UAV)), a flying car, or the like. Further, the above flying object may be a Vertical Take-Off and Landing Aircraft (Vtol) or an electric VTOL (eVTOL). The flying object may be a tilt-rotor aircraft. The flying object may be a helicopter. Further, while the aforementioned flying object may include, for example, a rotary wing, it is merely an example and the flying object may be the one that can fly by autonomous control. The above flying object may either be an unmanned aircraft that carries a package or the like or a manned aircraft with a passenger on board.

Further, the autonomous movement may be a movement along a route that is set in advance, or may be a movement based on a remote control performed by a user within a moving range that is allowed in advance. Like in a mobile body that performs the latter movement, the mobile body to be authenticated may be controlled so as to move while autonomously performing posture control or the like according to an operation instruction (a moving direction, a moving speed and the like) in accordance with remote manipulation, and may include a mobile body that cannot perform autonomous movement along a route. In this manner, the mobile body to be authenticated may be, for example, a mobile body that moves by remote manipulation or a mobile body that autonomously moves under a predetermined control.

The acquisition unit 1a acquires, from an autonomously movable mobile body, remote identification information, position information indicating the current position of this mobile body, time information indicating the current time in this mobile body, and authentication information. The authentication information may be, for example, information in which remote identification information, position information, and time information are concealed. While the acquisition unit 1a is able to acquire these information items at one time, the procedure of the acquisition is not particularly limited. The acquisition unit 1a may first acquire, for example, remote identification information, position information, and time information, and then acquire authentication information. The acquisition unit 1a is connected to the mobile body to be authenticated via wireless communication, thereby being able to acquire the aforementioned various kinds of information items. This connection may instead be a wired connection depending on the type of the mobile body.

The remote identification information is information for managing a remote operation of the mobile body. The remote identification information may be used to identify a mobile body at a time when it is remotely operated, and therefore it may also be called body identification information. A more specific example of the remote identification information will be described in the second example embodiment.

The authentication information may be generated from the remote identification information, the position information, and the time information according to a method of digital signature, or may be generated by another method such as one-time password. However, the authentication information is not limited thereto and may be any kind of information by which authentication can be conducted by the collation unit 1b that will be described later.

The collation unit 1b executes collation based on all or part of the various kinds of information items acquired by the acquisition unit 1a. When authentication information is used for the collation, the collation unit 1b may include a function of de-concealing (decrypting) the concealed authentication information. The information to be collated with the authentication information in the collation unit 1b is not limited. When the unconcealed information is acquired in the acquisition unit 1a, the collation unit 1b may execute collation using the aforementioned unconcealed information. In this case, the collation unit 1b may be configured to collate the authentication information acquired by the acquisition unit 1a with at least one of the remote identification information, the position information, and the time information acquired by the acquisition unit 1a. Alternatively, the collation unit 1b may collate at least one of the remote identification information, the position information, and the time information acquired by the acquisition unit 1a with the corresponding information stored in advance.

Further, the mobile body authentication apparatus 1 may be formed of its body and a terminal apparatus that can be connected to the body and may cause the above-described terminal apparatus to function as a part of the mobile body authentication apparatus 1. In this case, the above-described terminal apparatus receives, from the mobile body, at least one of position information, time information, and authentication information regarding this mobile body, and executes collation based on the received information, whereby it is possible to detect whether or not unauthorized information or falsified information is transmitted. In this case, the main body side of the mobile body authentication apparatus 1 obtains a result of the detection from the aforementioned terminal apparatus as one of the results of the collation. Further, the main body side of the mobile body authentication apparatus 1 may execute the collation to check whether the authentication information transmitted from the mobile body is legitimate or collate the information transmitted from the mobile body with remote identification information registered in advance, the information on a moving plan for moving the mobile body, or the like. Accordingly, the mobile body authentication apparatus 1 is able to detect spoofing or the like.

The output unit 1c outputs the result of the collation performed in the collation unit 1b. The output destination in the output unit 1c may be, for example, a display device (not shown) that is provided in the mobile body authentication apparatus 1, a terminal apparatus or the like that can be connected to the mobile body authentication apparatus 1, and the output destination may be determined in advance. In this manner, the mobile body authentication apparatus 1 is able to prevent an autonomously movable mobile body from illegally moving without permission by spoofing or the like by performing the aforementioned collation and the output of the result of the collation.

With reference to the flowchart shown in FIG. 2, one example of a mobile body authentication method according to this example embodiment will be described. The mobile body authentication apparatus 1 may be formed of a computer or may be configured to include a computer. In the method shown in FIG. 2, this computer acquires remote identification information, position information, time information, and authentication information from the mobile body (Step S1). Next, the aforementioned computer executes collation based on all or part of the acquired information (Step S2), and outputs the result of the collation (Step S3).

Note that the mobile body authentication apparatus 1 may include a processor and a storage apparatus, although they are not shown in the drawings. This storage apparatus may include, for example, a non-volatile memory such as a flash memory or a Solid State Drive (SSD). In this case, the storage apparatus included in the mobile body authentication apparatus 1 stores a computer program (hereinafter it will be simply referred to as a program) for executing the aforementioned mobile body authentication method. Further, the processor causes a computer program to be loaded to a buffer memory such as a Dynamic Random Access Memory (DRAM) from the storage apparatus, and executes this program.

Each of the components of the mobile body authentication apparatus 1 may be implemented by special-purpose hardware. Further, some or all of the components of each component may each be implemented by a general-purpose or special-purpose circuitry, processor, or a combination of them. They may be configured using a single chip, or a plurality of chips connected through a bus. Some or all of the components of each apparatus may be implemented by a combination of the above-described circuitry, etc. and a program. Further, a Central Processing Unit (CPU), a Graphics Processing Unit (GPU), a Field-Programmable Gate Array (FPGA), and so on may be used as a processor. The descriptions regarding the components described here may also be applied to other apparatuses or systems that will be described below in the present disclosure.

Further, when some or all of the components of the mobile body authentication apparatus 1 are implemented by a plurality of information processing apparatuses, circuits, or the like, the plurality of information processing apparatuses, the circuits, or the like may be disposed in one place in a centralized manner or arranged in a distributed manner. For example, the information processing apparatuses, the circuits, and the like may be implemented as a form such as a client-server system, a cloud computing system or the like in which they are connected to each other through a communication network. Further, the functions of the mobile body authentication apparatus 1 may be provided in the form of Software as a Service (SaaS).

As described above, according to this example embodiment, it becomes possible to prevent an autonomously movable mobile body from illegally moving without permission.

### Second Example Embodiment

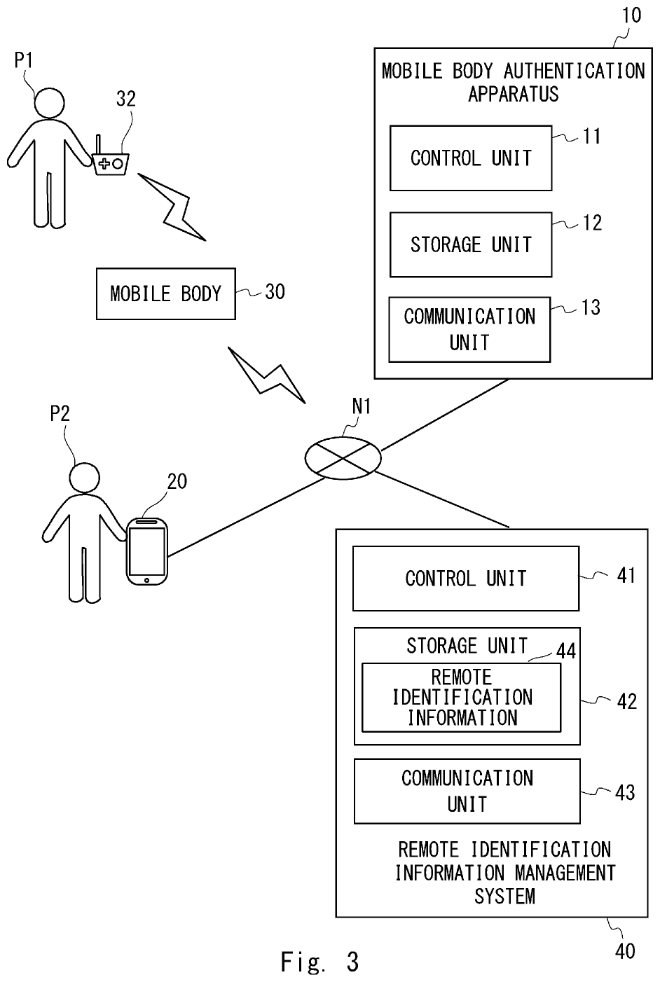

Next, a second example embodiment will be described with reference to FIGS. 3 to 7. Note that various examples described in the first example embodiment may be applied to the second example embodiment. FIG. 3 is a schematic diagram showing one configuration example of a mobile body authentication system according to this example embodiment.

As shown in FIG. 3, a mobile body authentication system according to this example embodiment (hereinafter it will be referred to as “this system”) is one example of a mobile body authentication system and is a system including a mobile body to be authenticated as a mobile body 30 and a mobile body authentication apparatus 10, which is an example of the mobile body authentication apparatus 1.

As shown in FIG. 3, in this system, the mobile body authentication apparatus 10, a terminal apparatus 20, and a remote identification information management system 40 that manages the remote identification information are connected to one another via a network N1. This network N1 is preferably a secure network. The remote identification information management system 40 may not be connected to the terminal apparatus 20 and it is sufficient that the remote identification information management system 40 be connected to the mobile body authentication apparatus 10. Further, while the terminal apparatus (or the mobile body authentication apparatus 10) can be wirelessly connected to the mobile body 30 in such a way that they can communicate with each other in this system, it is possible that the mobile body 30 may be spoofed by another mobile body or may be modified to disable communication.

Hereinafter, as shown in FIG. 3, this example embodiment will be described while taking an example in which this system is constructed in such a manner that the mobile body 30 (in a case in which it is not modified to disable communication) can be connected to the mobile body authentication apparatus 10 via the terminal apparatus 20. Note that, as an alternative configuration, a system in which the mobile body 30 can be directly connected to the mobile body authentication apparatus 10 wirelessly may be constructed or a system in which the mobile body authentication apparatus 10 is mounted on the terminal apparatus 20 as shown in FIG. 3 may be constructed.

In this system, a mobile body to be authenticated other than the mobile body 30 and the mobile body 30 may be of the same type or different types. A functional configuration example of the mobile body 30 will be described later.

The mobile body 30 can be controlled by a remote controller (manipulation apparatus) 32 by a user (operator) P1 or can move completely autonomously along a set route. The remote controller 32, which is an apparatus for remotely controlling the mobile body 30, is able to send an instruction for causing the mobile body 30 to perform a predetermined motion by wireless communication. The remote controller 32 may acquire data or the like of a sensor included in the mobile body 30. Further, the remote controller 32 may transmit predetermined information to the terminal apparatus 20 or the mobile body authentication apparatus 10 via the mobile body 30.

The mobile body authentication apparatus 10 may include a control unit 11 that controls the entire apparatus, a storage unit 12, and a communication unit 13 that performs external communication, and may be constructed as a single apparatus or a system in which the functions thereof are distributed in a plurality of apparatuses. The acquisition unit 1a shown in FIG. 1 may be exemplified by a control unit 11 and a communication unit 13 that acquires information in accordance with the control by the control unit 11, and the collation unit 1b in FIG. 1 may be exemplified by the control unit 11. Further, the output unit 1c shown in FIG. 1 may be exemplified by the control unit 11 and a display device (not shown) that displays the result of the authentication by the control performed by the control unit 11, or may be exemplified by the control unit 11 and a communication unit 13 that transmits the result of the collation to the terminal apparatus 20 by the control performed by the control unit 11.

Further, the mobile body authentication apparatus 10 may include an instruction receiving unit that receives an instruction for executing collation. In the example shown in FIG. 3, this instruction receiving unit may be formed of the communication unit 13 and the control unit 11. The control unit 11 receives the aforementioned instruction via the communication unit 13.

The terminal apparatus 20 may be an apparatus used by an administrator P2 who manages or monitors operations of a plurality of mobile bodies such as the mobile body 30, but it is not limited to an apparatus used by the administrator P2. That is, the terminal apparatus 20 may be an apparatus used by a person other than the administrator P2, such as an ordinary citizen or a police officer. Further, as the terminal apparatus 20, a terminal apparatus used by the administrator P2 and a terminal apparatus used by a person other than the administrator P2 may be incorporated into this system. In this case, information on the mobile body can be received by terminal apparatuses held by the administrator P2 and a person other than the administrator P2. However, in the following description, for the sake of clarification of the description, an example in which the terminal apparatus 20 is used by the administrator P2 will be described. The terminal apparatus 20 may be a portable computer such as a mobile telephone, a smartphone, or a tablet terminal, or may be a stationary Personal Computer (PC).

The remote identification information management system 40 may be one example of a management apparatus that is connected to the mobile body authentication apparatus 10 and manages remote identification information, and may be constructed as a single apparatus or a system whose functions are distributed in a plurality of apparatuses. The remote identification information management system may include a control unit 41 that controls its entirety, a storage unit 42 that stores remote identification information 44 for each mobile body, and a communication unit 43 that performs external communication via, for example, the network N1. In this manner, the remote identification information management system 40 manages the remote identification information 44 for each of the plurality of mobile bodies. This remote identification information 44 may be stored along with a flag indicating valid/invalid, and the content thereof may be manually or automatically updated as appropriate by the management side of the remote identification information management system 40. Further, a moving plan (the moving plan is also referred to as a flying plan when the mobile body 30 is a flying object such as an unmanned aircraft) regarding each mobile body such as the mobile body 30 may be requested and registered in advance in the storage unit 42.

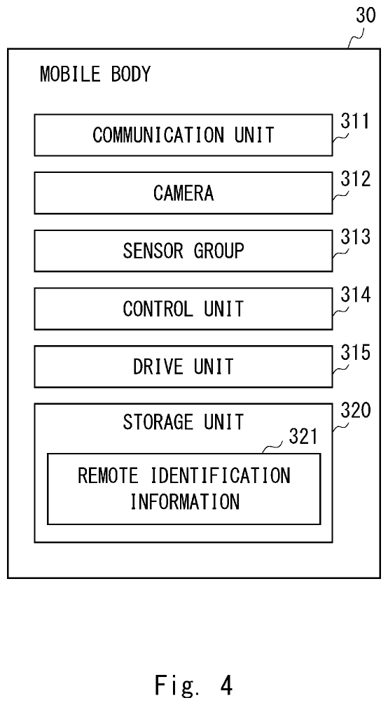

Referring next to FIG. 4, a configuration example of the mobile body 30 shown in FIG. 3 will be described. FIG. 4 is a block diagram showing one configuration example of the mobile body 30. The mobile body 30 may mainly include a communication unit 311, a camera 312, a sensor group 313, a control unit 314, a drive unit 315, and a storage unit 320.

The communication unit 311 includes an interface for enabling connection with the remote controller 32 wirelessly and an interface for enabling connection with the terminal apparatus 20 wirelessly. The radio communication system may be any system as long as there is no interference between these communications.

Further, as described above, in a configuration in which the mobile body 30 directly communicates with the mobile body authentication apparatus 10, the communication unit 311 may include an interface for enabling connection with the mobile body authentication apparatus 10 wirelessly. This wireless communication may be performed by any system.

In this example embodiment, like in the first example embodiment, authentication information, or information such as authentication information, remote identification information, position information, and time information is transmitted from the mobile body 30. While the information may be transmitted to the terminal apparatus 20, it may be transmitted also to the mobile body authentication apparatus 10. In either case, the mobile body 30 may be configured to be able to regularly transmit information such as remote identification information. That is, the mobile body 30 may be a mobile body that is set so as to move while regularly sending information such as remote identification information.

The camera 312 captures an image of scenery for each preset period while the mobile body 30 is moving, and generates image data related to the captured images. The image data related to the images captured by the camera 312 is supplied to the remote controller 32 via the communication unit 311. Further, the mobile body 30 may be configured to transmit this image data to the terminal apparatus 20 (or the mobile body authentication apparatus 10). The sensor group 313 indicates various kinds of sensors included in the mobile body 30. The sensor group 313 may include, for example, an antenna that acquires position information by a Global Navigation Satellite System (GNSS), a gyro sensor, a thermometer, a hygrometer or the like.

The control unit 314 includes a computation apparatus such as a CPU or an MCU and controls the entire mobile body 30. The drive unit 315, which is driven to enable the mobile body 30 to move, includes, for example, a motor for rotating a rotary wing (propeller) 31 used when the mobile body 30 moves. The storage unit 320, which is a storage apparatus including a non-volatile memory such as a flash memory or an SSD, at least stores remote identification information 321. In this example embodiment, processing in which a case where the remote identification information 321 is falsified by an operator P1 or the like is taken into account is performed.

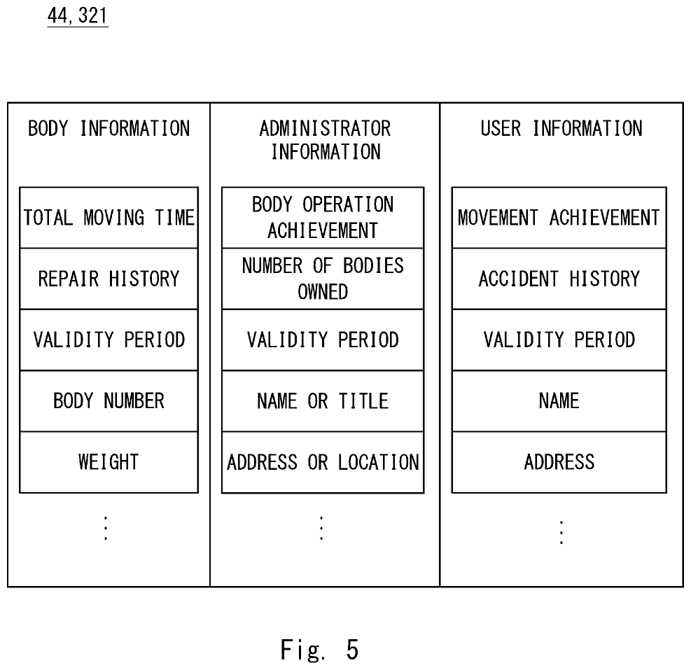

Next, with reference to FIG. 5, an example of the remote identification information 44 and 321 will be described. However, the remote identification information is not limited to the one exemplified here. FIG. 5 is a diagram showing one example of the remote identification information. While all or part of the values of the remote identification information 44 and the remote identification information 321 exemplified below are different for each mobile body, they are basically the same for one mobile body. While the remote identification information 44 cannot be externally falsified as long as the remote identification information management system 40 is constructed as a secure system, it is possible that the remote identification information 321 in the mobile body 30 may be falsified by the operator P1 or the like.

As illustrated in FIG. 5, the remote identification information 44 and 321 may include body information, administrator information, and user information, and each of the information items may be stored in association with, for example, an identifier of a mobile body.

The body information may include a total moving time, a repair history, and the like, and may be dynamically updated. Further, the body information may include a validity period of an operation qualification for operating the target mobile body 30, the body number (body ID), the weight, and the like.

The administrator information may include a body operation achievement, the number of bodies owned, and the like, and they may be dynamically updated. Further, the administrator information may include a validity period of a management qualification regarding the target mobile body 30, the name or the address of the administrator, the address or the location of the administrator, or the like.

The user information may include a movement achievement of a user, an accident history, and the like, and they may be dynamically updated. Further, the user information may include a validity period of a usage qualification for using the target mobile body 30, the name of the user P1, the user's address, and the like.

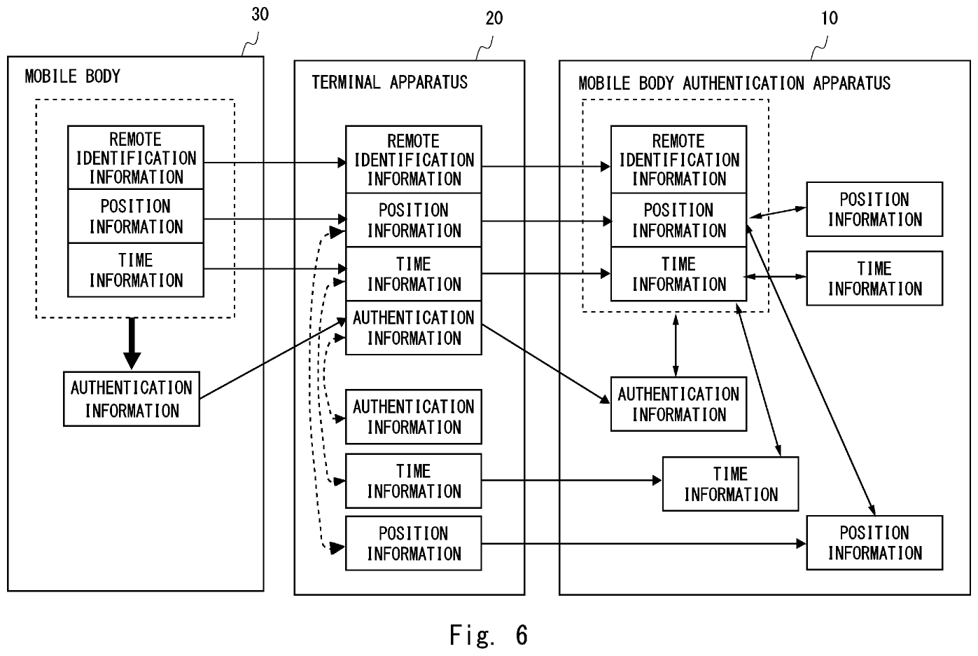

Referring next to FIG. 6, examples of transmission and reception of information between apparatuses and collation targets will be described. FIG. 6 is a schematic view for describing transmission and reception of information and collation in the mobile body authentication system shown in FIG. 3. In FIG. 6, uni-directional thin line arrows indicate a flow of information, uni-directional thick line arrows indicate a flow of information that involves processing, and bidirectional thin line arrows indicate collation processing. Further, bidirectional thin broken arrows indicate collation processing in the terminal apparatus 20.

As described in the first example embodiment, in this example embodiment as well, various kinds of information items from the mobile body 30 are received by the mobile body authentication apparatus 10 as body authentication and anti-spoofing measures, and execute collation. While various kinds of information items may be sent regularly by the mobile body 30, they may also be obtained as a result of the terminal apparatus 20 sending an information transmission request to the mobile body 30.

With the aforementioned configuration, this system is able to perform the following processing in a state in which the administrator P2 is watching the mobile body 30.

When the control unit 11 of the mobile body authentication apparatus 10 has received an instruction for executing collation, the control unit 11 acquires information from the mobile body 30 via the communication unit 13 and executes collation. This instruction may also be performed by the terminal apparatus 20 specifying remote identification information in a state in which the terminal apparatus 20 accesses the remote identification information management system directly or via the mobile body authentication apparatus 10, and viewing the moving schedule, and the terminal apparatus 20 may send an information transmission request to the mobile body 30.

At the time of the collation, the control unit 11 not only executes collation of the acquired authentication information with the remote identification information 321, the time information, and the position information, but also performs the following collation as well. That is, the control unit 11 further executes at least one of collation of time information on the mobile body 30 with time information indicating the current time in itself or the current time in the terminal apparatus 20, or collation of position information on the mobile body 30 with position information indicating the current position of itself or the current position of the terminal apparatus 20.

A specific example will be given. First, the terminal apparatus 20 acquires, from the mobile body 30, position information indicating the current position of the mobile body 30, time information indicating the current time, the remote identification information 321, and the authentication information via radio communication with the mobile body 30. This authentication information may be the one that the mobile body 30 has generated from the remote identification information 321, position information, and time information, and they may be generated by any method.

Further, the data format that is used for the transmission from the mobile body 30 to the terminal apparatus 20 and transmission from the terminal apparatus 20 to the mobile body authentication apparatus 10 that will be described later is not limited. In this example embodiment, authentication (collation) based on authentication information created from the remote identification information including the body ID or the like, the time information, and the position information is executed, and body authentication and anti-spoofing measures are conducted.

Next, the terminal apparatus 20 transmits position information indicating the current position of the terminal apparatus 20 and time position indicating the current time of the terminal apparatus 20 to the mobile body authentication apparatus 10 along with the remote identification information 321, the position information, the time information, and the authentication information received from the mobile body 30.

Further, the mobile body authentication apparatus 10 decrypts (de-conceals) the received authentication information by decoding or the like, and collates the received authentication information with the remote identification information 321, the position information, and the time information that have also been received to check if the received authentication information is the falsified information or not. In this manner, the authentication information is, for example, information generated from the information including the remote identification information 321, the position information, and the time information, and collation may be executed after this authentication information is decrypted.

Further, the mobile body authentication apparatus 10 respectively collates the time information and the position information on the mobile body 30 that have been received with the time information and position information included in an operation plan regarding the received remote identification information 321. Further, the terminal apparatus 20 may transmit the position information and the time information of the terminal apparatus 20 to the mobile body authentication apparatus 10 in advance, and collate the position information and the time information on the mobile body 30 that have been received by the mobile body authentication apparatus 10 with the position information and the time information on the terminal apparatus 20 that have been received. This case means that checking by comparing the position and the time of the terminal apparatus 20 in the terminal apparatus 20 with the position and the time of the mobile body 30 is executed by the mobile body authentication apparatus 10. As a matter of course, this checking may be executed by the terminal apparatus 20. For example, the terminal apparatus 20 may collate at least one of the time information, the position information, and the authentication information received from the mobile body 30 with the time information on itself, the position information on itself, and the authentication information held by itself (bidirectional thin broken arrows in FIG. 6). The terminal apparatus 20 is able to transmit the result of the collation to the mobile body authentication apparatus 10 or another destination.

Further, the mobile body authentication apparatus 10 is also able to access the remote identification information management system 40 to collate the remote identification information 321 received from the terminal apparatus 20 with the remote identification information 44 of the target mobile body 30 stored in the remote identification information management system 40. That is, the mobile body authentication apparatus 10 is also able to collate the acquired remote identification information 321 with the available remote identification information managed by the remote identification information management system 40.

The mobile body authentication apparatus 10 may execute collation of each information item (or receive the result of the collation regarding a part of the information), determine that the collation has been successful when the collation of each of all the information items has been successful, and determine that collation has been failed otherwise. Further, if it is impossible to execute collation, it can be determined that collation has failed in a case where all the necessary information items cannot be received from the mobile body 30, including a case where the mobile body 30 is modified in such a way that it cannot transmit information. Then, the mobile body authentication apparatus 10 outputs the result of the determination (the result of the collation) by replying to the terminal apparatus 20 which is instruction source, or the like. Note that the result of the collation may be output only when the collation has failed. Further, the mobile body authentication apparatus 10 may be configured to transmit the result of the collation to at least one of a system (not shown) of a police that cracks down on suspicious mobile bodies or a system (not shown) in Ministry of Land, Infrastructure, Transport and Tourism.

According to the aforementioned processing, the mobile body authentication apparatus 10 is able to execute body authentication of the mobile body 30 and detection of spoofing regarding the remote identification information, the time, and the position, and output the result of the body authentication and the detection of spoofing. Further, while the above description has been given based on the assumption that all the remote identification information, the position, and the time are collated, this system may be constructed to collate any one or two of the information items.

Further, when authentication has failed (that is, when spoofing or the like has been detected), the mobile body authentication apparatus 10 preferably notifies various destinations as follows that the authentication has failed. The destinations may include one or more of the terminal apparatus 20 used by the administrator P2 or the like, the mobile body 30, or an administrator or a user of the mobile body 30 (a registered person who is a victim of spoofing), an operator of the mobile body authentication apparatus 10, police, Ministry of Land, Infrastructure, Transport and Tourism, and the like.

Further, when the collation has failed, the mobile body authentication apparatus 10 preferably transmits alert information to the mobile body 30 that is a transmission source of the authentication information via the communication unit 13. While this transmission may be executed directly from the mobile body authentication apparatus 10, it may be executed via the terminal apparatus 20 as well. As a matter of course, because the mobile body 30 may be modified in such a way that the alert information cannot be received from the terminal apparatus 20 or that the alert information will be ignored, the mobile body 30 transmits such alert information only when it can perform communication.

Further, the mobile body authentication apparatus 10 may also transmit an instruction for causing the mobile body 30 to be forced to land (a forced-landing signal) via the terminal apparatus 20. In this case as well, this transmission can be executed when the terminal apparatus 20 can communicate with the mobile body 30 and the mobile body 30 is able to receive this instruction without ignoring this instruction.

Further, in this system, the mobile body authentication apparatus 10 accesses the remote identification information management system 40, whereby a configuration in which visual observation by the administrator P2 is not necessary may be employed. In this case as well, as a processing example after the collation, processing similar to that performed with the configuration which requires visual observation may be employed.

It is assumed that the mobile body authentication apparatus 10 acquires position information indicating the current position of the mobile body 30 via the terminal apparatus 20 (or directly) in order to eliminate the need for the visual observation by the administrator P2. Then, at the time of a collation, the mobile body authentication apparatus 10 may further execute collation with the time information and the position information set in the storage unit 42 in advance as an operation plan (a moving plan) for operating the mobile body 30 regarding the time information, the position information, and the remote identification information 321 on the mobile body 30. This operation plan may be the one requested in advance. Note that such a collation with the operation plan may be executed also when visual observation is required.

Further, while the above description has been given based on the assumption that the collation is basically executed only in the mobile body authentication apparatus 10, a part or whole of the collation may be executed by the terminal apparatus 20, as briefly described above. That is, the terminal apparatus 20 may also be configured to execute collation based on the remote identification information, the time information, the position information, and the authentication information, whereby the terminal apparatus 20 is able to detect spoofing. In the case in which the collation is executed in the terminal apparatus 20, the processing for the result of the collation may be basically the same as that described with regard to the mobile body authentication apparatus 10. However, the mobile body authentication apparatus 10 may be included as the destination to which the result of the collation is sent. That is, when authentication has failed (that is, in a case where spoofing or the like has been detected), the terminal apparatus 20 preferably notifies various destinations as follows that authentication has failed. These notification destinations may include one or more of the mobile body authentication apparatus 10, the mobile body 30, the administrator or the user of the mobile body 30 (a registered person who is a victim of spoofing), the operator of the mobile body authentication apparatus 10, police, Ministry of Land, Infrastructure, Transport and Tourism, and so on.

Accordingly, this system may be configured to execute the following collations (1) in a case where the terminal apparatus 20 has received various kinds of information items from the mobile body 30 and (2) in a case where the mobile body authentication apparatus 10 has received various kinds of information items from the mobile body 30. In the case of (1), the terminal apparatus 20 receives the remote identification information, the position information, and the time information from the mobile body 30, collates these information items with the position information and the time information of the terminal apparatus 20, and checks whether or not unauthorized information is sent or any information item is falsified. Further, the terminal apparatus 20 receives authentication information from the mobile body 30 and checks whether or not the mobile body 30 that has sent information is a legitimate mobile body by executing collation with, for example, information to be authenticated prepared in advance. In the case of (2), the mobile body authentication apparatus 10 receives the remote identification information, the position information, and the time information that have been sent by the mobile body 30 from the mobile body 30 or the terminal apparatus 20, compares these information items with the position information and the time information of the flying plan registered in advance for each of remote identification information items, and checks whether or not they match each other. Further, the mobile body authentication apparatus 10 receives the authentication information sent from the mobile body 30 and authenticates whether or not this mobile body 30 that has sent information is the legitimate mobile body by executing collation with, for example, the information to be authenticated prepared in advance.

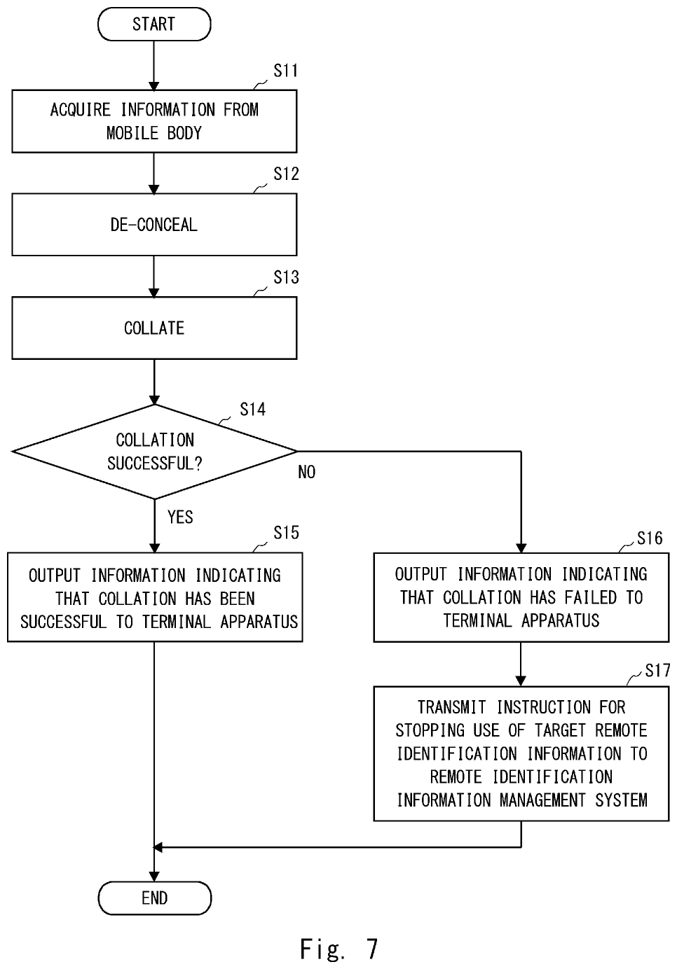

Referring next to FIG. 7, one example of collation processing in this system (the mobile body authentication system in FIG. 3) will be described in brief. FIG. 7 is a flowchart for describing one example of collation processing in this system.

In this system, first, the mobile body authentication apparatus 10 acquires various kinds of information items (the remote identification information 321, the time information, the position information, and the authentication information) from the mobile body 30 via the terminal apparatus 20 (Step S11). While it is possible to acquire the position information and the time information of the terminal apparatus 20 in Step S11 as described above, if the mobile body authentication apparatus 10 is disposed in a position close to the terminal apparatus 20, the position information indicating the position of the mobile body authentication apparatus 10 or time information may be used as well.

Next, the mobile body authentication apparatus 10 decrypts (de-conceals), of the received information, information that needs to be decrypted (in this case, authentication information) (Step S12), and collates the information after decryption and information that does not need to be decrypted with information prepared by itself (Step S13).

Next, the mobile body authentication apparatus 10 determines whether or not the collation of the mobile body 30 has been entirely successful from the result of the collation regarding each information item (Step S14). When the collation has been successful, information indicating that the collation has been successful is transmitted (output) to the terminal apparatus 20 (Step S15), and thereby the processing is ended. On the other hand, when the collation has failed (in the case of NO in Step S14), information indicating that the collation has failed is transmitted (output) to the terminal apparatus 20 (Step S16), an instruction for stopping the use of the target remote identification information 321 is transmitted to the remote identification information management system 40 (Step S17), and thereby the processing is ended.

Steps S16 and S17 may be performed in any order. Further, as a matter of course, the content of the instruction transmitted in Step S17 may include information indicating that the collation has failed or may be only information indicating that the collation has failed. In the remote identification information management system 40 that has received this instruction or the information indicating that the collation has failed, the control unit 41 causes the remote identification information 321 to stop using the remote identification information 44 that corresponds to at least the body number, or stores the remote identification information 44 as a target that requires special attention.

The remote identification information of a target whose usage should be stopped may be remote identification information where some of the information items (e.g., only the user, or only the user and the administrator) regarding the remote identification information 321 to which a stop-use instruction is sent match each other. The same holds true for the case in which the remote identification information is stored as the target that requires special attention. In this manner, the remote identification information management system 40 may change the state of the remote identification information to a stop-use state or a state which requires special attention as the target whose usage should be stopped or the target that requires special attention. This can be executed by changing the operation qualification or the management qualification or by changing the associated flag. Further, when there is no remote identification information 321 to which the stop-use instruction is sent, the remote identification information management system 40 may store the remote identification information in the storage unit 42 as a target that requires special attention.

As described above, the remote identification information management system 40 manages the remote identification information on each of a plurality of mobile bodies, and when the remote identification information management system 40 has received an instruction for stopping the usage of the remote identification information from the mobile body authentication apparatus 10, the remote identification information management system 40 preferably sets the state of the remote identification information regarding the mobile body related to this instruction to an unable state. Further, while the example in which the instruction for stopping the use of the target remote identification information 321 is transmitted to the remote identification information management system 40 has been described in Step S17, a configuration in which the mobile body authentication apparatus 10 is included in the remote identification information management system 40 may also be employed. In this case, the usage of the target remote identification information 321 is stopped in accordance with the above instruction.

As described above, according to this example embodiment, it becomes possible to prevent a mobile body such as the mobile body 30 from illegally moving without permission.

### Example of Hardware Configuration, Etc.

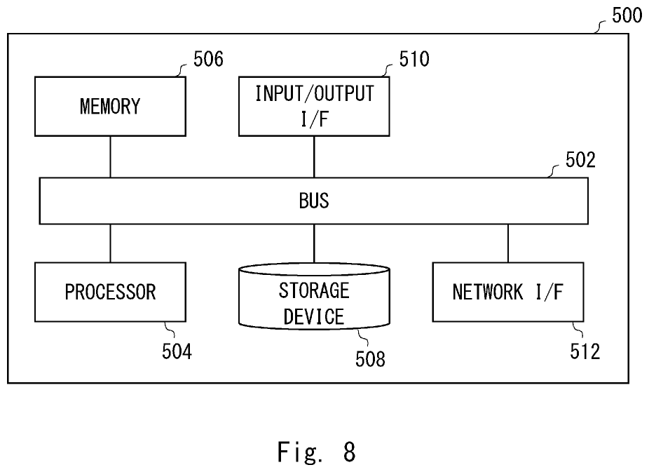

Hereinafter, with reference to FIG. 8, a case in which each functional configuration in each apparatus such as the mobile body authentication apparatus according to the present disclosure is implemented by a combination of hardware with software will be described. FIG. 8 is a block diagram illustrating a hardware configuration of a computer.

The mobile body authentication apparatus, the management apparatus, the terminal apparatus, and the manipulation apparatus according to the present disclosure can implement the aforementioned functions by a computer 500 including a hardware configuration shown in FIG. 8. The computer 500 may be a portable computer such as a smartphone or a tablet terminal or may be a stationary computer such as a PC. The computer 500 may be a special-purpose computer designed to implement each of the apparatuses, or may be a general-purpose computer. The computer 500 is able to implement a desired function as a predetermined application is installed therein.

The computer 500 includes a bus 502, a processor 504, a memory 506, a storage device 508, an input/output interface (I/F) 510, and a network interface (I/F) 512. The bus 502 is a data transmission path for enabling the processor 504, the memory 506, the storage device 508, the input/output interface 510, and the network interface 512 to transmit and receive data among them. However, the method for connecting the processor 504 and the like to one another is not limited to the bus connection.

The processor 504 may be any type of processor such as a CPU, a GPU or an FPGA. The memory 506 is a main memory unit that is implemented using a Random Access Memory (RAM) or the like. The storage device 508 is an auxiliary storage device that is implemented with a hard disk, an SSD, a memory card, or a Read Only Memory (ROM). The storage device 508 stores a program for achieving a desired function. The processor 504 loads this program into the memory 506 to execute the loaded program, thereby implementing each functional configuration unit of each apparatus.

The input/output interface 510 is an interface for connecting the computer 500 to an input/output device. An input device such as a keyboard and an output device such as a display device are connected, for example, to the input/output interface 510. The network interface 512 is an interface for connecting the computer 500 to the network.

In each example embodiment, the aforementioned program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks). The examples further include CD-Read Only Memory (ROM), CD-R, CD-R/W. The examples further include semiconductor memories (such as mask ROM, Programmable ROM (PROM), Erasable PROM (EPROM), flash ROM, Random Access Memory (RAM), etc.). The program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Note that the present invention is not limited to the aforementioned example embodiments and may be changed as appropriate without departing from the spirit of the present invention.

While the present invention has been described with reference to the example embodiments, the present invention is not limited by the aforementioned example embodiments. Various changes that can be understood by one skilled in the art may be made to the configurations and the details of the present application within the scope of the invention.

The whole or part of the example embodiments disclosed above can be described as, but not limited to, the following supplementary notes.

### (Supplementary Note 1)

A mobile body authentication apparatus comprising:
an acquisition unit configured to acquire, from an autonomously movable mobile body, remote identification information, which is information for managing a remote operation of the mobile body, position information indicating a current position of the mobile body, time information indicating a current time in the mobile body, and authentication information;
a collation unit configured to execute collation based on all or part of the information acquired by the acquisition unit; and
an output unit configured to output a result of the collation in the collation unit.

### (Supplementary Note 2)

The mobile body authentication apparatus according to supplementary Note 1, comprising an instruction receiving unit configured to receive an instruction for executing the collation by the collation unit, wherein
when the instruction receiving unit has received the instruction, the acquisition unit executes the acquisition, and the collation unit executes collation of time information of the mobile body with time information indicating the current time in the mobile body authentication apparatus.

### (Supplementary Note 3)

The mobile body authentication apparatus according to supplementary Note 1 or 2, comprising an instruction receiving unit configured to receive an instruction for executing the collation by the collation unit, wherein
when the instruction receiving unit has received the instruction, the acquisition unit executes the acquisition, and the collation unit executes collation of position information on the mobile body with position information indicating the current position of the mobile body authentication apparatus.

### (Supplementary Note 4)

The mobile body authentication apparatus according to supplementary Note 2 or 3, wherein
the instruction receiving unit receives the instruction from the terminal apparatus connected to the mobile body authentication apparatus, and
the output unit notifies, when the collation in the collation unit has failed, the terminal apparatus that has sent the instruction at the instruction receiving unit of the failure in the collation.

### (Supplementary Note 5)

The mobile body authentication apparatus according to any one of supplementary Notes 1 to 4, wherein the collation unit collates time information and position information in the mobile body with time information and position information that are set in advance as an operation plan for operating the mobile body according to the remote identification information.

### (Supplementary Note 6)

The mobile body authentication apparatus according to any one of supplementary Notes 1 to 5, wherein the authentication information acquired by the acquisition unit is information in which information including the remote identification information, the position information, and the time information acquired by the acquisition unit is concealed.

### (Supplementary Note 7)

The mobile body authentication apparatus according to any one of supplementary Notes 1 to 6, wherein the output unit transmits, when the collation in the collation unit has failed, alert information to the mobile body that is a transmission source of the authentication information.

### (Supplementary Note 8)

The mobile body authentication apparatus according to any one of supplementary Notes 1 to 7, wherein the output unit transmits, when the collation in the collation unit has failed, an instruction for stopping the use of the remote identification information to a management apparatus that manages the remote identification information.

### (Supplementary Note 9)

The mobile body authentication apparatus according to supplementary Note 8, wherein the collation unit further collates the remote identification information acquired by the acquisition unit with available remote identification information managed by the management apparatus.

### (Supplementary Note 10)

A mobile body authentication system comprising:
the mobile body authentication apparatus according to supplementary Note 8 or 9 and a management apparatus connected to the mobile body authentication apparatus, wherein
the management apparatus manages the remote identification information on each of a plurality of mobile bodies, and
when the management apparatus has received an instruction for stopping the use of the remote identification information from the mobile body authentication apparatus, the management apparatus changes the state of the remote identification information regarding a mobile body according to the instruction to an unable state.

### (Supplementary Note 11)

A mobile body authentication method, wherein a computer performs the following processing of:
acquiring, from an autonomously movable mobile body, remote identification information, which is information for managing a remote operation of the mobile body, position information indicating a current position of the mobile body, time information indicating a current time in the mobile body, and authentication information,
executing collation based on all or part of the acquired information; and
outputting a result of the collation.

### (Supplementary Note 12)

A program for causing a computer to execute the following processing of:
acquiring, from an autonomously movable mobile body, remote identification information, which is information for managing a remote operation of the mobile body, position information indicating a current position of the mobile body, time information indicating a current time in the mobile body, and authentication information;
executing collation based on all or part of the acquired information; and
outputting a result of the collation.

While the present application has been described above with reference to the example embodiments, the present application is not limited to the above example embodiments. Various changes that may be understood by one skilled in the art may be made to the configurations and the details of the present application within the scope of the invention.

This application is based upon and claims the benefit of priority from Japanese Patent Application No. 2021-062053, filed on Mar. 31, 2021, the disclosure of which is incorporated herein in its entirety by reference.

### REFERENCE SIGNS LIST

N1 NETWORK
P1 OPERATOR
P2 ADMINISTRATOR
1 MOBILE BODY AUTHENTICATION APPARATUS
1A ACQUISITION UNIT
1B COLLATION UNIT
1C OUTPUT UNIT
10 MOBILE BODY AUTHENTICATION APPARATUS
11 CONTROL UNIT
12 STORAGE UNIT
13 COMMUNICATION UNIT
20 TERMINAL APPARATUS
30 MOBILE BODY
32 REMOTE CONTROLLER
40 REMOTE IDENTIFICATION INFORMATION MANAGEMENT SYSTEM
41 CONTROL UNIT
42 STORAGE UNIT
43 COMMUNICATION UNIT
44 REMOTE IDENTIFICATION INFORMATION
311 COMMUNICATION UNIT
312 CAMERA
313 SENSOR GROUP
314 CONTROL UNIT
315 DRIVE UNIT
320 STORAGE UNIT
321 REMOTE IDENTIFICATION INFORMATION (STORED INSIDE MOBILE BODY)
500 COMPUTER
502 BUS
504 PROCESSOR
506 MEMORY
508 STORAGE DEVICE
510 INPUT/OUTPUT I/F
512 NETWORK I/F

What is claimed is:

1. A mobile body authentication apparatus comprising
at least one memory configured to store instructions, and
at least one processor configured to execute the instructions to:
acquire, from an autonomously movable mobile body, remote identification information, which is information for managing a remote operation of the mobile body, position information indicating a current position of the mobile body, time information indicating a current time in the mobile body, and authentication information;
execute collation based on all or part of the acquired information; and
output a result of the collation in the collation.

2. The mobile body authentication apparatus according to claim 1, wherein
the at least one processor is further configured to execute the instructions to:
receive a collation instruction for executing the collation; and
when the at least one processor has received the collation instruction, acquire the remote identification information, the position information, the time information, and the authentication information, and execute collation of time information of the mobile body with time information indicating the current time in the mobile body authentication apparatus.

3. The mobile body authentication apparatus according to claim 1, wherein
the at least one processor is further configured to execute the instructions to:
receive a collation instruction for executing the collation; and
when the at least one processor has received the collation instruction, acquire the remote identification information, the position information, the time information, and the authentication information, and execute collation of position information on the mobile body with position information indicating the current position of the mobile body authentication apparatus.

4. The mobile body authentication apparatus according to claim 2, wherein
the at least one processor is further configured to execute the instructions to:
receive the collation instruction from the terminal apparatus connected to the mobile body authentication apparatus; and
notify, when the collation has failed, the terminal apparatus that has sent the collation instruction to the mobile body authentication apparatus of the failure in the collation.

5. The mobile body authentication apparatus according to claim 1, wherein the collation is a collation that collates time information and position information in the mobile body with time information and position information that are set in advance as an operation plan for operating the mobile body according to the remote identification information.

6. The mobile body authentication apparatus according to claim 1, wherein the authentication information is information in which information including the remote identification information, the position information, and the time information is concealed.

7. The mobile body authentication apparatus according to claim 1, wherein the at least one processor is further configured to execute the instructions to transmit, when the collation has failed, alert information to the mobile body that is a transmission source of the authentication information.

8. The mobile body authentication apparatus according to claim 1, wherein the at least one processor is further configured to execute the instructions to transmit, when the collation has failed, an instruction for stopping the use of the remote identification information to a management apparatus that manages the remote identification information.

9. The mobile body authentication apparatus according to claim 8, wherein the collation further includes a collation that collates the remote identification information with available remote identification information managed by the management apparatus.

10. A mobile body authentication system comprising:
the mobile body authentication apparatus according to claim 8 and a management apparatus connected to the mobile body authentication apparatus, wherein
the management apparatus manages the remote identification information on each of a plurality of mobile bodies, and
when the management apparatus has received an instruction for stopping the use of the remote identification information from the mobile body authentication apparatus, the management apparatus changes the state of the remote identification information regarding a mobile body according to the instruction to an unable state.

11. A mobile body authentication method, wherein a computer executes the following processing of:
acquiring, from an autonomously movable mobile body, remote identification information, which is information for managing a remote operation of the mobile body, position information indicating a current position of the mobile body, time information indicating a current time in the mobile body, and authentication information;
executing collation based on all or part of the acquired information; and
outputting a result of the collation.

12. A non-transitory computer readable medium storing a program for causing a computer to execute the following processing of:
acquiring, from an autonomously movable mobile body, remote identification information, which is information for managing a remote operation of the mobile body, position information indicating a current position of the mobile body, time information indicating a current time in the mobile body, and authentication information;
executing collation based on all or part of the acquired information; and
outputting a result of the collation.

13. The mobile body authentication method according to claim 11, wherein the computer further execute the following processing of:
receiving a collation instruction for executing the collation; and
when the at least one processor has received the collation instruction, acquiring the remote identification information, the position information, the time information, and the authentication information, and executing collation of time information of the mobile body with time information indicating the current time in the mobile body authentication apparatus.

14. The mobile body authentication method according to claim 11, wherein the computer further execute the following processing of:
receiving a collation instruction for executing the collation; and
when the at least one processor has received the collation instruction, acquiring the remote identification information, the position information, the time information, and the authentication information, and executing collation of position information on the mobile body with position information indicating the current position of the mobile body authentication apparatus.

15. The mobile body authentication method according to claim 13, wherein the computer further execute the following processing of:
receiving the collation instruction from the terminal apparatus connected to the mobile body authentication apparatus; and
notifying, when the collation has failed, the terminal apparatus that has sent the collation instruction to the mobile body authentication apparatus of the failure in the collation.

16. The mobile body authentication method according to claim 11, wherein the collation is a collation that collates time information and position information in the mobile body with time information and position information that are set in advance as an operation plan for operating the mobile body according to the remote identification information.

17. The non-transitory computer readable medium according to claim 12, wherein the program further causes the computer to execute the following processing of:
receiving a collation instruction for executing the collation; and
when the at least one processor has received the collation instruction, acquiring the remote identification information, the position information, the time information, and the authentication information, and executing collation of time information of the mobile body with time information indicating the current time in the mobile body authentication apparatus.

18. The non-transitory computer readable medium according to claim 12, wherein the program further causes the computer to execute the following processing of:
receiving a collation instruction for executing the collation; and
when the at least one processor has received the collation instruction, acquiring the remote identification information, the position information, the time information, and the authentication information, and executing collation of position information on the mobile body with position information indicating the current position of the mobile body authentication apparatus.

19. The non-transitory computer readable medium according to claim 17, wherein the program further causes the computer to execute the following processing of:
receiving the collation instruction from the terminal apparatus connected to the mobile body authentication apparatus; and
notifying, when the collation has failed, the terminal apparatus that has sent the collation instruction to the mobile body authentication apparatus of the failure in the collation.

20. The non-transitory computer readable medium according to claim 12, wherein the collation is a collation that collates time information and position information in the mobile body with time information and position information that are set in advance as an operation plan for operating the mobile body according to the remote identification information.
